(19) United States
(12) Patent Application Publication
(10) Pub. No.: US 2010/0189633 A1
(43) Pub. Date: Jul. 29, 2010

(54) METHOD FOR PRODUCING CHLORINE BY GAS PHASE OXIDATION

(75) Inventors: Ralph Schellen, Dormagen (DE); Leslaw Mleczko, Dormagen (DE); Stephan Schubert, Leverkusen (DE); Oliver Felix Karl Schlüter, Leverkusen (DE); Aurel Wolf, Wulfrath (DE)

Correspondence Address: Briscoe, Kurt G.;Norris McLaughlin & Marcus, PA, 875 Third Avenue, 8th Floor, New York, NY, 10022, US

(73) Assignee: BAYER TECHNOLOGY SERVICES GMBH, LEVERKUSEN (DE)

(21) Appl. No.: 12/668,682

(22) PCT Filed: Jul. 1, 2008
(86) PCT No.: PCT/EP08/05352

§ 371 Date: Jan. 12, 2010

(30) Foreign Application Priority Data
Jul. 13, 2007 (DE) 10 2007 033 106.3
Jul. 13, 2007 (DE) 10 2007 033 113.6
Jul. 13, 2007 (DE) 10 2007 033 114.4

(51) Int. Cl. C01B 7/01; B01J 8/04

(52) U.S. Cl. 423/502; 422/190

(57) ABSTRACT

The present invention relates to a process for preparing chlorine by catalytic gas phase oxidation of hydrogen chloride with oxygen, by reacting the process gas mixture in a reactor in at least two separate reaction zones under adiabatic conditions over catalyst beds, and by passing the process gas mixture leaving at least one reaction zone subsequently through a heat exchanger connected downstream of the particular reaction zone. It further relates to a reactor system for preparing chlorine by catalytic gas phase oxidation of hydrogen chloride with oxygen by means of the process according to the invention.

The present invention relates to a process for preparing chlorine by catalytic gas phase oxidation of hydrogen chloride with oxygen, by reacting the process gas mixture in a reactor in at least two separate reaction zones under adiabatic conditions over catalyst beds, and by passing the process gas mixture leaving at least one reaction zone subsequently through a heat exchanger connected downstream of the particular reaction zone. It further relates to a reactor system for preparing chlorine by catalytic gas phase oxidation of hydrogen chloride with oxygen by means of the process according to the invention.

The process for catalytic hydrogen chloride oxidation with oxygen in an exothermic equilibrium reaction, developed by Deacon in 1868, was at the beginning of industrial chlorine chemistry:

4HCl+O₂ [symbol] 2Cl₂+2H₂O

However, chloralkali electrolysis forced the industrial application of the Deacon process very much onto the sidelines. Almost the entire production of chlorine was by electrolysis of aqueous sodium chloride solutions. However, the attractiveness of the Deacon process has increased again in recent times, since the global demand for chlorine is growing more rapidly than the demand for sodium hydroxide solution, a coproduct of NaCl electrolysis. This development is favourable to the process for preparing chlorine by oxidation of hydrogen chloride, which is decoupled from the preparation of sodium hydroxide solution. Furthermore, the hydrogen chloride precursor is easy to obtain; it is obtained as a coproduct in large amounts, for example, in phosgenation reactions, for instance in isocyanate preparation.

The removal and use of the heat of reaction is an important point in the performance of the Deacon process. An uncontrolled temperature rise, which could be 600 to 900° C. from the start to completion of the Deacon reaction, would firstly lead to permanent damage to the catalyst, and high temperatures secondly cause an unfavourable shift in the reaction equilibrium in the direction of the reactants with a corresponding deterioration in the yield. It is therefore desirable to keep the temperature of the catalyst bed within a range of 150 to 600° C. in the course of the process.

The catalysts first used for the Deacon process, for instance supported catalysts with the active composition of CuCl₂, had only a low activity. Although it was possible to enhance the activity by increasing the reaction temperature, it was disadvantageous that the volatility of the active components at relatively high temperature led to a rapid deactivation of the catalyst. Similar problems with the volatility of the catalyst components also occur in the case of use of more active ruthenium chloride/oxide. The oxidation of hydrogen chloride to chlorine is additionally an equilibrium reaction. The equilibrium position shifts away from the desired end product with increasing temperature.

In established processes, the catalyst is therefore used in the form of a fluidized, thermally stabilized bed. According to EP 0 251 731 A2, the temperature of the catalyst bed is controlled through the outer wall; according to DE 10 2004 006 610 A1, the temperature of the fluidized bed is controlled by means of a heat carrier arranged in the bed. Effective heat removal from this process is countered by problems resulting from an inhomogeneous residence time distribution and catalyst attrition, both of which lead to losses of conversion.

Published specifications WO 2004/037718 and WO 2004/014845 mention, in general form, the possibility of adiabatic catalytic hydrogen chloride oxidation as well as the preferred isothermal processes. However, specific embodiments of an adiabatic hydrogen chloride oxidation are not described. It thus remains entirely unclear how the heat of reaction of the exothermic reaction can be removed and damage to the catalyst can be avoided in a fully adiabatic operating mode of the overall process. In fact, the hydrogen chloride oxidation, according to these documents, however, proceeds isothermally as a fixed bed process in tube bundle reactors, which require a cooling system which has to be controlled in a complicated manner. In principle, all tube bundle reactors described are also very complex and cause high capital costs. Problems regarding mechanical stability and homogeneous thermostating of the catalyst bed which rise rapidly with construction size make large units of such a type uneconomic.

Plate heat exchangers provided with channels as constituents of a chemical reactor are disclosed in WO 2001/54806. However, this application does not relate to the Deacon process.

There is consequently still a need for a process for preparing chlorine by adiabatic catalytic gas phase oxidation of hydrogen chloride with oxygen, in which the temperature of the reaction mixture and also of the catalyst can be controlled better. More particularly, it should be possible to limit the maximum temperature in order to avoid damage to the catalyst, and the minimum temperature should not be too low to obtain a sufficiently high space-time yield.

It is an object of the present invention to provide such a process. More particularly, it is an object of the invention to provide a process for preparing chlorine by catalytic gas phase oxidation of hydrogen chloride with oxygen, by reacting the process gas mixture in a reactor in at least two separate reaction zones under adiabatic conditions over catalyst beds, and by subsequently passing the process gas mixture leaving at least one reaction zone through a heat exchanger connected downstream of the particular reaction zone.

The object is achieved in accordance with the invention by virtue of the heat exchanger comprising plates layered one on top of another and bonded to one another, the individual plates having at least two separate fluid flow channels in accordance with a predeterminable pattern and the plates provided with fluid flow channels being arranged such that the process gas mixture in a first flow path direction and the heat exchange medium used in the heat exchanger in a second flow path direction flow through the heat exchanger.

In the context of the invention, a reactor is understood to mean the overall system into which the hydrogen chloride and oxygen reactants are introduced and react with one another, and the reaction products are discharged. The hydrogen chloride reactant may originate, for example, from the reaction of amines with phosgene to synthesize isocyanates. The reactor comprises reaction zones which constitute regions spatially delimited from one another, in which the desired reaction proceeds. As a result of the corrosive reaction gases, the reactor is constructed preferably from stainless steel, such as 1.4571 or 1.4828, or nickel 2.4068, or nickel-base alloys such as 2.4610, 2.4856 or 2.4617, Inconel or Hastelloy.

Catalyst beds are present in the reaction zones. A catalyst bed is understood here to mean an arrangement of the catalyst in all manifestations known per se, for example fixed bed, moving bed or fluidized bed. Preference is given to a fixed bed arrangement. This comprises a catalyst bed in the actual sense, i.e. loose, supported or unsupported catalyst in any shape and in the form of suitable packings.

The term “catalyst bed” as used here also encompasses continuous regions of suitable packings on a support material or structured catalyst supports. Examples of these include ceramic honeycombs which have comparatively high geometric surface areas and are to be coated, or corrugated sheets of metal wire mesh on which, for example, catalyst granule is immobilized.

The structure of the heat exchanger is such that it can be described as a sequence of plates layered one on top of another and bonded to one another. The plates may be bonded to one another in a positively fitting or positively bonded manner. One example of a positive bond is welding or diffusion welding.

Fluid flow channels are incorporated into the plates, through which channels a fluid can flow from one side of a plate to the other side, for example to the opposite side. The channels may be linear, i.e. form the shortest possible path. However, they may also form a longer path, by virtue of them being designed in accordance with a wavy, meandering or zigzag pattern. The cross-sectional profile of the channels may, for example, be semicircular, elliptical, square, rectangular, trapezoidal or triangular. The fact that at least two separate fluid flow channels are present per plate means that these channels run through the plate and the fluid flowing therein cannot switch between the channels.

The flow path direction can be defined by the vector between the plane within which the starting points of the fluid flow channels lie and the plane within which the end points of the fluid flow channels of one plate or of a stack of plates lie. It thus indicates the general direction of the flow of the fluid through the heat exchanger. Thus, a first flow path direction indicates the direction in which the process gas mixture flows through the heat exchanger or, continuing, through the reaction zone. A second flow path direction indicates the route of the heat exchange medium. This can flow, for example, in cocurrent, countercurrent or crosscurrent to the process gas mixture.

Overall, the heat exchanger works sufficiently effectively that the temperature of the process gas mixture on entry into the catalyst bed of the next reaction zone, even when reaction is setting in, does not lead to the occurrence of local overheating of the catalyst.

By means of the process according to the invention, a flow rate, expressed in tonnes per year of chlorine gas produced, of ≧100 to ≦400 000, of ≧1000 to ≦300 000 or of ≧10 000 to ≦200 000 can be achieved.

By means of the process according to the invention, it is possible to achieve a conversion of HCl of ≧10% to ≦99%, of ≧50% to ≦95% or of ≧80% to ≦90%.

The process according to the invention achieves effective temperature control of the Deacon process, such that the formation of uncontrolled zones with elevated temperature, so-called hot spots, especially in the entrance region of the catalyst bed, can be prevented. Thus, lifetimes of the catalyst which, expressed in years, may be from ≧1 to ≦10, ≧2 to ≦6 or ≧3 to ≦4 are enabled.

In one embodiment of the present invention, the catalyst bed is configured as a structured packing. In a further embodiment of the present invention, the catalyst is present in the catalyst bed as a monolithic catalyst. The use of structured catalysts such as monoliths, structured packings, but also coated catalysts principally has the advantage of lowering the pressure drop. In addition to the advantages for the overall process, given a lower specific pressure drop, the volume for the catalyst and the heat exchange area to be introduced into the construction of the reactor can be achieved by a lower flow cross section with longer reaction stages and heat exchanger stages. A further advantage of the use of structured catalysts is that shorter diffusion paths of the reactants are needed in the thinner catalyst layers, which can be associated with an increase in the catalyst selectivity.

Fluid flow channels may be incorporated in the structured catalyst bed, the hydraulic diameter of the fluid flow channels being ≧0.1 mm to ≦10 mm, preferably ≧0.3 mm to ≦5 mm, more preferably ≧0.5 mm to ≦2 mm. The specific surface area of the catalyst grows when the hydraulic diameter falls. When the diameter becomes too small, an excessively great pressure drop occurs. In addition, in the event of impregnation with a catalyst suspension, it is also possible for a channel to become blocked.

In a further embodiment of the present invention, the hydraulic diameter of the fluid flow channels in the heat exchanger is ≧10 μm to ≦10 mm, preferably ≧100 μm to ≦5 mm, more preferably ≧1 mm to ≦2 mm. At these diameters, effective heat exchange is ensured to a particular degree.

In a further embodiment of the present invention, the process comprises ≧6 to ≦50, preferably ≧10 to ≦40 and more preferably ≧20 to ≦30 reaction zones. In the case of such a number of reaction zones, the material use can be optimized with regard to the conversion of HCl gas. A lower number of reaction zones would have the consequence of unfavourable temperature control. The entrance temperature would have to be selected at a lower level, which would cause the catalyst to become less active. Moreover, the average reaction temperature then also falls. A higher number would not justify the costs and material demands owing to the small increase in conversion. Specifically the handling of the ultracorrosive gases HCl, O₂ and Cl₂ requires durable and correspondingly expensive materials for the reactor.

In a further embodiment of the present invention, hydrogen chloride and oxygen are fed simultaneously into the reactor. This may mean mixing in a preliminary chamber without the catalyst bed or the simultaneous introduction of the gases into the first reaction zone. This has the advantage that the overall starting gas stream can be utilized for the absorption and removal of the heat of reaction in all catalyst beds. In addition, it is possible to pass the gases into a heat exchanger connected upstream, in order to heat them. The process according to the invention also makes possible a simplification of the reactor apparatus. Dispensing with additional pipelines enables better temperature control. Generally, it is also possible that the waste heat of the preceding reaction stages is used to heat the process gas mixture before the next reaction zone.

In a further embodiment of the present invention, the length of at least one reaction zone is ≧0.01 m to ≦5 m, preferably ≧0.03 m to ≦1 m, more preferably ≧0.05 m to ≦0.5 m. The length here is understood to mean the length of the reaction zones in the flow direction of the process gas mixture. The reaction zones may all have the same length or be of different lengths. For example, the early reaction zones may be short, since sufficient reactants are available and excessive heating of the reaction zone should be avoided. The late reaction zones may then be long, in order to increase the overall conversion of the process, while there is less risk of excessive heating of the reaction zone. The lengths themselves which have been specified have been found to be advantageous, since the reaction cannot proceed with the desired conversion in the case of shorter lengths and the flow resistance with respect to the process gas mixture rises too greatly in the case of greater lengths. Moreover, the catalyst exchange is more difficult to conduct in the case of greater lengths.

In a further embodiment of the present invention, the catalyst comprises a support and a catalytically active constituent/component.

As the catalytically active constituent/component, the catalyst in the reaction zones independently comprises substances which are selected from the group comprising copper, potassium, sodium, chromium, cerium, gold, bismuth, iron, ruthenium, osmium, uranium, cobalt, rhodium, iridium, nickel, palladium and/or platinum, and oxides, chlorides and/or oxychlorides of the aforementioned elements. Particularly preferred compounds comprise here: copper(I) chloride, copper(II) chloride, copper(I) oxide, copper(II) oxide, potassium chloride, sodium chloride, chromium(III) oxide, chromium(IV) oxide, chromium(VI) oxide, bismuth oxide, ruthenium oxide, ruthenium chloride, ruthenium oxychloride, rhodium oxide, uranium oxides, uranium chlorides and/or uranium oxychlorides.

Very particular preference is given to catalysts with catalytically active constituents comprising uranium oxides, for example UO₃, UO₂, UO, or the nonstoichiometric phases resulting from mixtures of these species, for example U₃O₅, U₂O₅, U₃O₇, U₃O₈, U₄O₉.

The catalyst may be applied to a support. The support fraction may comprise: titanium oxide, tin oxide, aluminium oxide, zirconium oxide, vanadium oxide, chromium oxide, uranium oxide, silicon oxide, siliceous earth, carbon nanotubes, cerium dioxide or a mixture or compound of the substances mentioned, especially mixed oxides, such as silicon aluminium oxide. Further particularly preferred support materials are tin oxide, carbon nanotubes, uranium oxides, for example UO₃, UO₂, UO, and the nonstoichiometric phases resulting from mixtures of these species, for example U₃O₅, U₂O₅, U₃O₇, U₃O₈, U₄O₉.

The supported ruthenium catalysts may be obtained, for example, by impregnating the support material with aqueous solutions of RuCl₃ and optionally a promoter for doping. The catalyst can be shaped after or preferably before the impregnation of the support material.

For the doping of the catalysts, suitable promoters are alkali metals, such as lithium, sodium, rubidium, caesium and particularly potassium, alkaline earth metals such as calcium, strontium, barium and particularly magnesium, rare earth metals such as scandium, yttrium, praseodymium, neodymium and particularly lanthanum and cerium, and additionally cobalt and manganese, and mixtures of the aforementioned promoters.

The shaped bodies can subsequently be dried at a temperature of ≧100° C. to ≦400° C. under a nitrogen, argon or air atmosphere and optionally be calcined. Preferably, the shaped bodies are first dried at ≧100° C. to ≦150° C. and then calcined at ≧200° C. to ≦400° C.

In a further embodiment of the present invention, the particle size of the catalyst is independently ≧1 mm to ≦10 mm, preferably ≧1.5 mm to ≦8 mm, more preferably ≧2 mm to ≦5 mm. The particle size may correspond to the diameter in the case of approximately spherical catalyst particles, or to the dimension in longitudinal direction in the case of approximately cylindrical catalyst particles. The particle size ranges specified have been found to be advantageous, since a high pressure drop occurs in the case of relatively small particle sizes, and the usable particle surface area in relation to the particle volume falls and hence the achievable space-time yield becomes lower in the case of larger particles.

In a further embodiment of the present invention, the catalyst has a different activity in different reaction zones, the activity of the catalyst in the reaction zones preferably increasing viewed along the flow direction of the process gases. When the concentration of the reactants in the earlier reaction stages is high, the temperature of the process gas mixture will also rise significantly as a consequence of their reaction. In order not to experience an undesired temperature rise in the early reaction zones, a catalyst with a relatively low activity can therefore be selected. Another effect is that inexpensive catalysts can be used. In order to achieve a maximum conversion of the reactants still remaining in late reaction zones, more active catalysts can be used there. Overall, it thus becomes possible through the different activity of the catalysts in the individual reaction zones to keep the temperature of the reaction in a narrower and hence also more favourable temperature range.

One example of a change in the catalyst activity would be an activity in the first reaction zone of 30% of the maximum activity and a rise in steps of 5%, 10%, 15% or 20% per reaction zone until the activity in the last reaction zone is 100%.

The activity of the catalyst can be established, for example, by virtue of the quantitative proportions of the catalytically active compound being different with the same base material of the support, same promoter and same catalytically active compound. In addition, in the sense of macroscopic dilution, it is also possible for particles with no activity to be added.

In a further embodiment of the present invention, a continuous exchange of a fixed bed catalyst is carried out.

In a further embodiment of the present invention, the absolute entrance pressure of the process gases upstream of the first reaction zone is ≧1 bar to ≦60 bar, preferably ≧2 bar to ≦20 bar, more preferably ≧3 bar to ≦8 bar. The absolute entrance pressure determines the amount of reactants and the reaction kinetics in the process gas mixture. The ranges reported have been found to be favourable, since lower pressures bring about low, economically unattractive conversions of the reactants, and, at higher pressures, the compressor output required becomes high, which implies cost disadvantages.

In a further embodiment of the present invention, the entrance temperature of the process gases upstream of a reaction zone is ≧250° C. to ≦630° C., preferably ≧310° C. to ≦480° C., more preferably ≧330° C. to ≦400° C. The entrance temperature may be the same or individually different for all zones. It is one of the factors responsible for the speed and the degree of the temperature rise in the process gas mixture. The entrance temperatures selected permit a maximum conversion in the reaction zone without the temperature within the zone rising to undesired values.

In a further embodiment of the present invention, the maximum temperature in a reaction zone is ≧340° C. to ≦650° C., preferably ≧350° C. to ≦500° C., more preferably ≧365° C. to ≦420° C. The maximum temperature in a reaction zone may be the same for all zones or individually different. It can be adjusted by process parameters such as pressure or composition of the process gas mixture, activity of the catalyst and length of the reaction zone. The maximum temperature determines both the reaction conversion and the degree of discharge or of deactivation of the catalyst. The temperatures selected permit a maximum conversion in the reaction zone, without the catalyst being significantly discharged or deactivated.

In general, the temperature in the catalyst beds can preferably be controlled by at least one of the following measures:
dimensioning of the catalyst beds,
control of the heat removal between the catalyst beds,
addition of feed gases between the catalyst beds,
molar ratio of the reactants,
concentration of the reactants,
addition of inert gases, especially nitrogen, carbon dioxide, upstream of and/or between the catalyst beds.

In principle, the catalysts or the supported catalysts may have any desired shape, for example spheres, rods, Raschig rings, or granules or tablets.

In a further embodiment of the present invention, the reaction zones connected in series are operated at a varying average temperature. This can be established, for example, via the control of the heat exchangers connected between the catalyst beds. This means that, within a sequence of catalyst beds, the temperature can be allowed either to rise or fall from catalyst bed to catalyst bed. Thus, it may be particularly advantageous to allow the average temperature initially to rise from catalyst bed to catalyst bed to increase the catalyst activity, and then to allow the average temperature to fall again in the last catalyst bed downstream to shift the equilibrium. On the other hand, it may be advantageous to operate the reaction zones connected in series at a rising average temperature. Thus, the conversion of the reactants can be carried out initially with a greater safety margin from the desired upper temperature limit. Later in the reaction, when a lower level of reactants is present, the conversion can be driven further by increasing the average temperature.

In a further embodiment of the present invention, the residence time of the process gases in the reactor overall is ≧0.5 s to ≦60 s, preferably ≧1 s to ≦30 s, more preferably ≧2 s to ≦10 s. Shorter residence times and the associated low space-time yield are economically unattractive. In the case of higher residence times, no significant additional increase in the space-time yield occurs, such that such a process operation is likewise economically unattractive. Moreover, in the case of a higher residence time, the exit temperature rises above the maximum desired temperature.

In a further embodiment of the present invention, unconverted reactant gases are introduced back into the start of the reactor. Consequently, it is a circulation process. Unconverted reactant gases are especially hydrogen chloride and oxygen.

In a further embodiment of the present invention, the heat exchange medium which flows through a heat exchanger is selected from the group comprising liquids, boiling liquids, gases, organic heat carriers, salt melts and/or ionic liquids, preference being given to selecting water, partly evaporating water and/or steam. Partly evaporating water is understood to mean that, in the individual fluid flow channels of the heat exchanger, liquid water and steam are present alongside one another. This gives rise to the advantages of a high heat transfer coefficient on the part of the heat exchange medium, a high specific heat absorption as a result of the evaporation enthalpy of the heat exchange medium, and a constant temperature over the channel of the heat exchange medium. Especially in the case of heat exchange medium conducted in crosscurrent to the reactant flow, the constant evaporation temperature is advantageous, since it enables uniform heat removal over all reaction channels. The reactant temperature can be regulated via the adjustment of the pressure level and hence of the temperature for the evaporation of the heat exchange medium.

In a further embodiment of the present invention, the mean logarithmic temperature difference between heat exchange medium and the product stream is ≧5 K to ≦300 K, preferably ≧10 K to ≦250 K, more preferably ≧50 K to ≦150 K. In the case of lower logarithmic temperature differences, the heat exchange area required becomes too great, which implies cost disadvantages. In the case of higher logarithmic temperature differences, the coolant has to be very cold. For example, low-energy steam is also of low value in the economic overall balance of a plant.

In a further embodiment of the present invention, the process is conducted such that the space-time yield, expressed in kg of Cl₂ per kg of catalyst, is ≧0.1 to ≦10, preferably ≧0.3 to ≦3, more preferably ≧0.5 to ≦2.

In a further embodiment of the present invention, the heat of reaction removed in the heat exchangers is used to raise steam. This makes the overall process more economically viable and enables, for example, the process to be operated profitably in an integrated system or an integrated site.

In a further embodiment of the present invention, the molar ratio of oxygen to hydrogen chloride before entry into the first reaction zone is ≧0.25 to ≦10, preferably ≧0.5 to ≦5, more preferably ≧0.5 to ≦2. An increase in the ratio of equivalents of oxygen per equivalent of hydrogen chloride can firstly accelerate the reaction and hence increase the space-time yield (amount of chlorine produced per unit reactor volume), and the equilibrium of the reaction is secondly shifted positively in the direction of the products.

In a further embodiment of the present invention, the process gases comprise an inert gas, preferably nitrogen and/or carbon dioxide. In addition, the inert gas has a proportion of the process gases of ≧15 mol % to ≦30 mol %, preferably ≧18 mol % to ≦28 mol %, more preferably ≧20 mol % to ≦25 mol %. By means of inert gases, it is possible to favourably influence the reaction temperature and the reaction kinetics. The proportions specified have been found to be favourable, since more reaction stages are required in the case of excessively small inert gas streams, and the operating costs rise too greatly in the case of excessively large inert gas streams, especially when the process is conducted in circulation.

The present invention further provides a reaction system for preparing chlorine by catalytic gas phase oxidation of hydrogen chloride with oxygen by means of the process of the present invention. More particularly, the present invention relates to a reactor system wherein the heat exchanger comprises plates layered one on top of another and bonded to one another, the individual plates having at least two separate fluid flow channels in accordance with a predeterminable pattern and the plates provided with fluid flow channels being arranged such that the process gas mixture flows through the heat exchanger in a first flow path direction and the heat exchange medium used in the heat exchanger in a second flow path direction. It is also advantageous when the reactor system comprises ≧6 to ≦50, preferably ≧10 to ≦40 and more preferably ≧20 to ≦30 reaction zones.

The present invention is illustrated further with reference to Examples 1 and 2 which follow. These examples relate to the temperature profile of the process gas mixture when it reacts in reaction zones by the process according to the invention and is cooled again in downstream heat exchangers. The examples further relate to the conversion of HCl achieved.

### EXAMPLE 1

In this example, the process gas mixture flowed through a total of 24 catalyst stages, i.e. through 24 reaction zones. Downstream of each catalyst stage was disposed a heat exchanger which cooled the process gas mixture before it entered the next catalyst stage. The process gas used at the outset was a mixture of HCl (38.5 mol %), O₂ (38.5 mol %) and inert gases (Ar, Cl₂, N₂, CO₂; 23 mol % in total). The entrance pressure of the process gas mixture was 5 bar. The length of the catalyst stages, i.e. of the reaction zones, was uniform and was in each case 7.5 cm. The activity of the catalyst was adjusted such that it was the same in all catalyst stages. The process was carried out such that a loading of 1.2 kg of HCl per kg of catalyst and hour was attained. There was no metered addition of further process gas constituents upstream of the individual catalyst stages. The residence time in the plant was a total of 2.3 seconds.

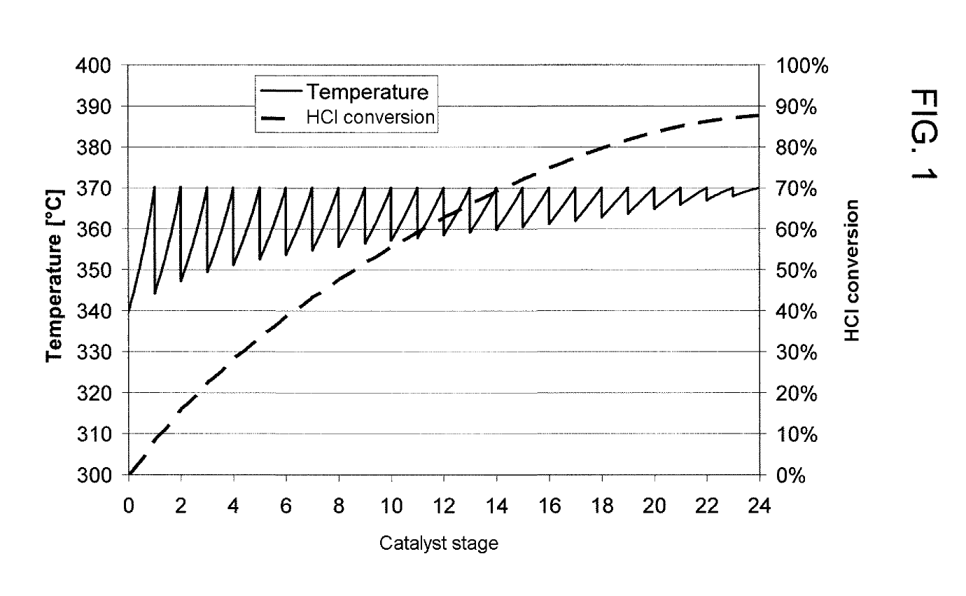

The results are shown in FIG. 1. The individual catalyst stages are shown on the x axis, such that a spatial profile of the developments in the process becomes visible. On the left-hand y-axis, the temperature of the process gas mixture is specified. The temperature profile over the individual catalyst stages is shown as a continuous line. On the right-hand y-axis, the overall conversion of HCl is specified. The profile of the conversion over the individual catalyst stages is shown as a broken line.

It can be seen that the entrance temperature of the process gas mixture upstream of the first catalyst stage is about 340° C. As a result of the exothermic reaction to give chlorine gas under adiabatic conditions, the temperature rises to about 370° C., before the process gas mixture is cooled again by the downstream heat exchanger. The entrance temperature upstream of the next catalyst stage is about 344° C. As a result of exothermic adiabatic reaction, it rises again to about 370° C. The sequence of heating and cooling continues further. The entrance temperatures of the process gas mixture upstream of the individual catalyst stages rise with increasing number of stages. This is possible since the amount of reactants capable of reaction is lower at stages later in the reaction and, correspondingly, the risk that the temperature will leave the optimal range of the process as a result of the exothermic reaction falls. Consequently, the temperature of the process gas mixture can be kept closer to the optimal temperature for the particular composition.

The conversion of HCl after the 24th stage was 88.1% overall.

### EXAMPLE 2

In this example, the process gas mixture flowed through a total of 18 catalyst stages, i.e. through 18 reaction zones. Downstream of each catalyst stage was disposed a heat exchanger, which cooled the process gas mixture before it entered the next catalyst stage. The process gas used at the outset was a mixture of HCl (38.5 mol %), O₂ (38.5 mol %) and inert gases (Ar, Cl₂, N₂, CO₂; 23 mol % in total). The entrance pressure of the process gas mixture was 5 bar. The length of the catalyst stages, i.e. of the reaction zones, was uniform and was in each case 15 cm. The activity of the catalyst was adjusted such that it increased with the number of catalyst stages. The relative catalyst activities were as follows:

| | |
|---|---|
| Stages 1 and 2 | 30% |
| Stages 3 and 4 | 40% |
| Stages 5 and 6 | 50% |
| Stages 7 and 8 | 60% |
| Stages 9 and 10 | 70% |
| Stages 11 and 12 | 80% |
| Stages 13 and 14 | 90% |
| Stages 15 and 16 | 100% |
| Stages 17 and 18 | 100% |

The process was carried out such that a loading of 1.12 kg of HCl per kg of catalyst and hour was achieved. There was no metered addition of further process gas constituents upstream of the individual catalyst stages. The residence time in the plant overall was 3.5 seconds.

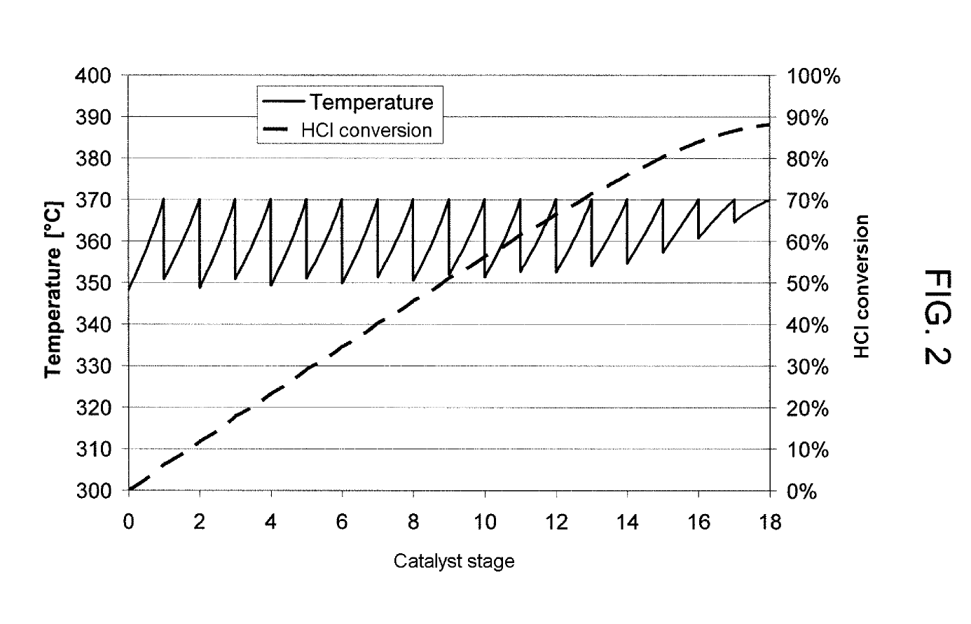

The results are shown in FIG. 2. The individual catalyst stages are shown on the x-axis, such that a spatial profile of the developments in the process becomes visible. On the left-hand y-axis, the temperature of the process gas mixture is specified. The temperature profile over the individual catalyst stages is shown as a continuous line. On the right-hand y-axis, the overall conversion of HCl is specified. The profile of the conversion over the individual catalyst stages is shown as a broken line.

It can be seen that the entrance temperature of the process gas mixture upstream of the first catalyst stage is about 350° C. As a result of the exothermic reaction to give chlorine gas under adiabatic conditions, the temperature rises to about 370° C., before the process gas mixture is cooled again by the downstream heat exchanger. The entrance temperature upstream of the next catalyst stage is again about 350° C. As a result of exothermic adiabatic reaction, it rises again to about 370° C. The sequence of heating and cooling continues further. The entrance temperatures of the process gas mixture upstream of the individual catalyst stages rise with increasing number of stages more slowly than in the case of Example 1. Overall, the variability of the process gas temperatures is actually lower. The intentional lower activity of the catalyst in the early stages enables the process gas mixture to be introduced with a higher entrance temperature without any risk of undesired overheating. Consequently, the temperature of the process gas mixture can be kept closer to the optimal temperature for the particular composition.

The conversion of HCl after the 18th stage was 88.1% overall.

1. A process for preparing chlorine by catalytic gas phase oxidation of hydrogen chloride with oxygen comprising reacting a process gas mixture in a reactor in at least two separate reaction zones under adiabatic conditions over catalyst beds, and subsequently passing the process gas mixture leaving at least one reaction zone through a heat exchanger connected downstream of the particular reaction zone, wherein the heat exchanger comprises plates layered one on top of another and bonded to one another, the individual plates having at least two separate fluid flow channels in accordance with a predeterminable pattern and the plates provides with fluid flow channels being arranged such that the process gas mixture in a first flow path direction and the heat exchange medium used in the heat exchanger in a second flow path direction flow through the heat exchanger.

2. The process according to claim 1, wherein the catalyst bed is configured as a structured packing.

3. The process according to claim 1, wherein the catalyst is present in the catalyst bed in the form of a monolithic catalyst.

4. The process according to claim 1, wherein the hydraulic diameter of the fluid flow channels in the heat exchanger is ≧10 μm to ≦10 mm.

5. The process according to claim 1 comprising ≧6 to ≦50 reaction zones.

6. The process according to claim 1, wherein hydrogen chloride and oxygen are fed simultaneously into the reactor.

7. The process according to claim 1, wherein the length of at least one reaction zone is ≧0.01 m to ≦5 m, preferably ≧0.03 m to ≦1 m, more preferably ≧0.05 m to ≦0.5 m.

8. The process according to claim 1, wherein the catalyst comprises at least one support and a catalytically active constituent/component.

9. The process according to claim 8, wherein the catalyst independently comprises, as the catalytically active constituent/component in the reaction zones, substances which are selected from the group consisting of copper, potassium, sodium, chromium, cerium, gold, bismuth, iron, ruthenium, osmium, uranium, cobalt, rhodium, iridium, nickel, palladium, platinum, oxides of the aforementioned elements, chlorides of the aforementioned elements and oxychlorides of the aforementioned elements.

10. The process according to claims 8, wherein the support comprises titanium oxide, tin oxide, aluminium oxide, zirconium oxide, vanadium oxide, chromium oxide, uranium oxide, silicon oxide, siliceous earth, carbon nanotubes, cerium dioxide or a mixture or compound of the substances mentioned.

11. The process according to claim 1, wherein the particle size of the catalyst is independently ≧1 mm to ≦10 mm.

12. The process according to claim 1, wherein the catalyst in different reaction zones has a different activity.

13. The process according to claim 1, wherein a continuous exchange of a fixed bed catalyst is carried out.

14. The process according to claim 1, wherein the absolute entrance pressure of the process gases upstream of the first reaction zone is ≧1 bar to ≦60 bar.

15. The process according to claim 1 wherein the entrance temperature of the process gases upstream of a reaction zone is ≧250° C. to ≦630° C.

16. The process according to claim 1 wherein the maximum temperature in a reaction zone is ≧340° C. to ≦650° C.

17. The process according to claim 1 wherein the series-connected reaction zones are operated at varying average temperature.

18. The process according to claim 1 wherein the residence time of the process gases in the reactor is a total of ≧0.5 s to ≦60 s.

19. The process according to claim 1 wherein unconverted reactants are introduced back into the start of the reactor.

20. The process according to claim 1 wherein the heat exchange medium which flows through a heat exchanger is selected from the group comprising liquids, boiling liquids, gases, organic heat carriers, salt melts and/or ionic liquids.

21. The process according to claim 1 wherein the mean logarithmic temperature difference between heat exchange medium and the product stream is ≧5 K to ≦300 K.

22. The process according to claim 1 wherein the process is conducted such that the space-time yield, expressed in kg of Cl₂ per kg of catalyst, is ≧0.1 to ≦10.

23. The process according to claim 1 wherein the heat of reaction removed in the heat exchangers is used to raise steam.

24. The process according to claim 1 wherein the molar ratio of oxygen to hydrogen chloride before entry into the first reaction zone is ≧0.25 to ≦10.

25. The process according to claim 1 wherein the process gases include an inert gas and the inert gas also has a proportion of the process gases of ≧15 mol % to ≦30 mol %.

26. A reactor system for preparing chlorine by catalytic gas phase oxidation of hydrogen chloride with oxygen by means of the process according to claim 1.
